(19) United States
(12) Patent Application Publication
(10) Pub. No.: US 2006/0021918 A1
(43) Pub. Date: Feb. 2, 2006

(54) Arrangement for separation of particles, and a separation method in connection with a process for manufacturing power cables

(76) Inventor: Svante Björk, (US)

Correspondence Address: LACASSE & ASSOCIATES, LLC, 1725 DUKE STREET, SUITE 650, ALEXANDRIA, VA, 22314, US

(21) Appl. No.: 11/198,160

(22) Filed: Aug. 8, 2005

Related U.S. Application Data
(63) Continuation of application No. PCT/SE04/00132, filed on Feb. 2, 2004.

(30) Foreign Application Priority Data
Feb. 3, 2003 (SE) 0300269-8

(51) Int. Cl. B07B 13/07

(52) U.S. Cl. 209/682

(57) ABSTRACT

The invention relates to an arrangement for separating particles from a flow of pellet-shaped or granular elements that are fed from a source to a subsequent workstation for processing the said elements. The invention is characterized in that the said arrangement comprises a screen arrangement that is arranged downstream of the said source and that comprises a plurality of projections extending in principally the same direction as the direction of feed for the said elements and with principally V-shaped spaces between the said projections, which spaces increase gradually in the direction of flow, whereby particles of a size that is smaller than the size of the said elements are separated from the said flow of elements by falling down through the said spaces. The invention also relates to a method for manufacturing electrical power cables, and an arrangement for inspecting elements.

### BACKGROUND OF THE INVENTION

1. Field of Invention

The present invention relates to an arrangement for separation of particles, as claimed in the preamble to claim 1.

In particular, the invention is intended to be used in connection with the separation of particles in connection with optical inspection, checking and cleaning of granules of synthetic material, which in turn are used for the manufacture of electrical power cables.

The invention also relates to a separation method in connection with a process for manufacturing electrical power cables, as claimed in the preamble to the following claim 13.

The invention also relates to an arrangement for inspection of elements, as claimed in the preamble to the following claim 16.

2. Discussion of Prior Art

In the manufacture of electrical power cables for high and medium-high voltages, preferably of the order of 12 kV and higher, an electrical conductor is normally provided with a semi-conductive layer and a surrounding insulating covering. Synthetic materials, preferably polyethylene, are normally used for the manufacture of this covering. Cross-linked polyethylene or tree-retardant cross-linked polyethylene, XLPE or TRXLPE, are other materials that are suitable for this purpose.

Concerning electrical power cables, it is of the greatest importance that there are no contaminants in the insulating polyethylene covering, as such contaminants can lead to a limited life for the cable as a result of breakdown of the insulation material, which in turn leads to electrical puncture of insulation in the cable. Such puncture results in turn in the cable being damaged.

For the abovementioned reasons, during the manufacture of power cables for high and medium-high voltages, stringent requirements are imposed concerning the cleanliness of the raw material that is used for the cable's insulating polyethylene covering. This raw material consists normally of granules of polyethylene (also called pellets), that is material in the shape of small balls or grains. In order to meet these stringent cleanliness requirements, a fault control of these granules is carried out in connection with the manufacture of the power cable. In this way, the granules that have some form of defect (for example in the form of air bubbles, contaminants, variations in symmetry, variations in colour, etc.) are separated and discarded, as they could otherwise cause the abovementioned problems in the finished cable.

In order to solve the problems mentioned above, methods are already known by which the raw material, that is the granules themselves, are inspected, partly by sampling approximately 2-4% of the flow of material and partly by all the granules in a manufacturing process being checked with regard to cleanliness, which makes possible an extremely high degree of cleanliness of the material. Such a system is described in patent document PCT/SE99/00002. This system comprises a conveyor for moving the granules, and an optical detector which is arranged in a particular position in association with the conveyor and which is connected to a control unit. This control unit is in turn arranged to analyse the signal that is generated by the detector so that any defective granules that occur can be separated. This is carried out by the control unit being arranged to activate a special separating arrangement in the form of a set of nozzles for compressed air which are arranged under the conveyor at its end. If a defective granule is detected, a corresponding nozzle is activated, whereupon a jet of air is directed towards the granule in question precisely as it passes over the edge at the end of the conveyor. This means in turn that the granule is blown a little distance away and lands in a container for defective granules.

Although the abovementioned known method works satisfactorily in principle, there is still a need for an inspection system with increased effectiveness and with increased accuracy. In particular, it is the case that a considerable part of the contaminants that occur in the material in question consists of loose particles, that is particles that are not part of any granule but that occur as loose elements and that, in addition, can be expected to have a different trajectory to the granules when these pass over the edge at the end of the conveyor. This makes the detection of the particles more difficult, as they can lie under the flow of granules which are to be inspected. This means that there is a risk that they are not discovered and separated during the abovementioned type of optical detection. This applies both to visible particles (that is particles that are of the order of 100 μm or larger) and to smaller particles that are not visible to the naked eye.

In certain cases, as much as 70% or even more of the total amount of contaminants that are in a sample can consist of such loose contaminants.

There is thus a need for arrangements and methods for an effective separating of unwanted particles, in particular loose contaminants that are found in a larger quantity of granules, for example in connection with a subsequent inspection or extrusion in connection with a process for manufacturing power cables.

### SUMMARY OF THE INVENTION

The aim of the present invention is to provide an improved arrangement for separating unwanted loose particles, for example in connection with the inspection and sorting of granules.

This aim is achieved by means of an arrangement of the type mentioned in the introduction, with the characteristics described in claim 1.

Another aim of the invention is to provide an improved method in connection with the manufacture of electrical power cables, in which unwanted particles that can potentially weaken the insulation can be separated before an insulating covering is manufactured for the said power cables.

This aim is achieved by means of a method of the type mentioned in the introduction, with the characteristics described in claim 13.

Another aim of the invention is to provide an improved arrangement for inspecting principally granular elements that are fed towards an inspection station comprising an optical detector, which arrangement permits the separating of unwanted loose particles before or after the said inspection station.

This aim is achieved by means of an arrangement of the type mentioned in the introduction, with the characteristics described in claim 16.

### BRIEF DESCRIPTION OF THE DRAWINGS

The invention will be described in the following in greater detail with reference to a preferred embodiment and to the attached drawings, in which:

FIG. 1 shows a schematic side view of an arrangement as claimed in the present invention,

FIG. 2 shows a slightly enlarged detail view showing the function of the invention,

FIG. 3 shows a slightly enlarged perspective view of a sorting and separating arrangement that can be used in connection with the invention,

FIG. 4 shows a close-up view of a screen arrangement as claimed in the invention, and

FIG. 5 shows a side view of an alternative embodiment of the invention.

### DESCRIPTION OF THE PREFERRED EMBODIMENTS

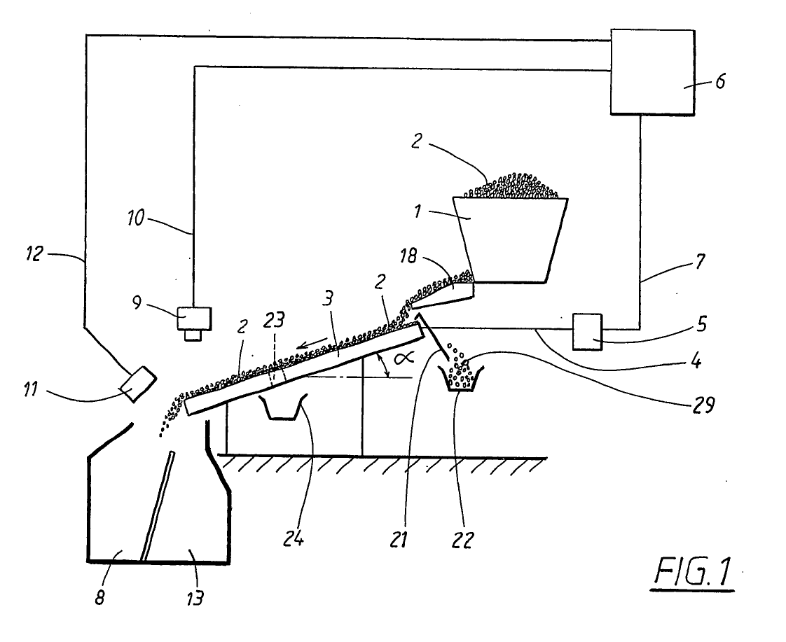

FIG. 1 shows a schematic and somewhat simplified side view of a sorting and detecting system in which the present invention can be used. According to a preferred embodiment, the system comprises a feeding arrangement, preferably in the form of a hopper 1 for a certain quantity of granules 2, that is to say elements principally in the shape of small balls or grains. The invention is particularly suitable for use in connection with a system for inspecting granules 2 of material which in turn is used for manufacturing electrical power cables for high and medium-high voltages (from approximately 12 kV and upwards), with the granules 2 constituting a raw material of polyethylene that is used for manufacturing an electrically insulating covering in such power cables.

The invention is not limited to the use of only such materials as mentioned above. Nor is the invention limited to being used with inspection and detection systems for such materials, but can be used for any form of feeding and conveying arrangement in which there is a need for the sorting or separating of unwanted particles (for example, in the form of contaminants) which are in loose form and which are of a size that is smaller than the granules from which the particles are to be separated. By this is meant that the particles that are intended to be separated do not constitute a part of the granular material that is to be inspected. It is characteristic of the type of separating that is carried out as claimed in the present invention that the particles that it is intended to sort and separate are considerably smaller in size than the material from which the particles are to be separated.

A system for optical inspection of granular or pellet-shaped elements is already known from patent document PCT/SE99/00002. According to a first embodiment, the present invention can be realized in connection with a feeding and conveying arrangement similar to this known system. This will now be described.

The feeding arrangement, that is the hopper 1, as claimed in FIG. 1 is connected to a conveyor arrangement 3 via an opening (not shown) at the bottom on the front of the hopper 1. The conveyor arrangement 3 is arranged to transport granules 2 in a direction that is indicated by an arrow in FIG. 1. According to the embodiment, the conveyor arrangement 3 consists of a vibrating feeder, that is a vibrating chute that feeds the granules forward by means of forward and backward vibrations in its longitudinal direction. For operation of the vibrating feeder 3, this is connected via a mechanical or magnetic connection 4 to a drive arrangement 5. The drive arrangement 5 is in turn connected to an electronics-based control unit 6, via an electrical connection 7.

The granules 2 are fed via the vibrating feeder 3 in a direction towards the end of the vibrating feeder 3 where a first container 8 is arranged to collect the granules that fall over the edge that constitutes the end of the vibrating feeder 3.

A short distance above the vibrating feeder 3 there is a detector 9, which consists preferably of a CCD camera. By means of the detector 9, an optical scan is carried out with the aim of detecting whether any of the granules that pass under the detector 9 are defective, that is whether any granule comprises, for example, a contaminant or air bubbles or whether the material is not homogenous. The detector 9 is connected to the control unit 6 via another electrical connection 10. The control unit 6 is arranged to receive a signal from the scan by the detector 9. In this way, the control unit 6 can determine whether any granule that passes under the detector 9 is defective.

The detector 9 is positioned a short distance before the end of the vibrating feeder 3, for optical scanning of the granules 2 just before they reach this end. If the control unit 6 determines that any passing granule is defective, this will bring about an activation of a special sorting and separating arrangement 11 in the form of a transverse set of nozzles for supplying compressed air. This sorting and separating arrangement 11, which is connected to the control unit 6 via another electrical connection 12, is arranged above the end of the vibrating feeder 3, across its longitudinal direction. According to what will be described in detail below, the control unit 6 can activate the sorting and separating arrangement 11 when the detected defective granule passes over the edge at the end of the vibrating feeder 3. This can be calculated in the control unit 6 depending upon the position of the detector 9 and the speed at which the vibrating feeder 3 transports the granules 2. As the detector 9 is also arranged to detect in which position across the vibrating feeder 3 the defective granule is located, the sorting and separating arrangement 11 can be activated (that is, a particular nozzle can be activated) when the defective granule passes the edge at the end of the vibrating feeder 3. This activation leads to a correspondingly positioned air valve in the sorting and separating arrangement 11 being activated, so that the defective granule is acted upon by a jet of air and directed to a second container 13 which is intended for defective granules. The second container 13 is located close to the first container 8 and is separated from this by means of a partition 14.

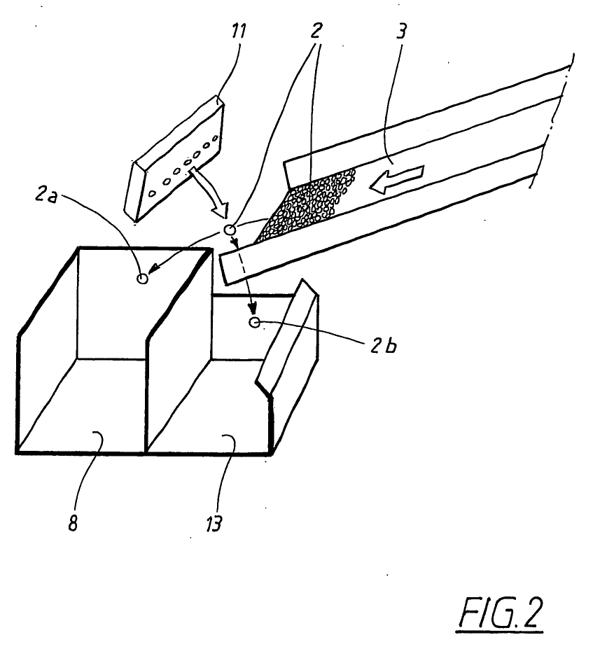

With reference to FIG. 2, which is a somewhat enlarged perspective view showing the end of the vibrating feeder 3 and the sorting and separating arrangement 11, it can be seen how the granules 2 are fed forward in the direction towards the edge that constitutes the end of the vibrating feeder 3. This is indicated schematically by a first granule 2a that is assumed to be fault-free and that thus falls down into the first container 8. If instead the granule had been judged to be defective, the sorting and separating arrangement 11 would have been activated instead, in accordance with what has been described above, whereupon air would have been emitted via an air nozzle and in this way would have directed the granule to the second container 13. This is indicated schematically by the reference numeral 2b.

As is shown in FIG. 1 in particular, the vibrating feeder 3 is arranged so that it forms a certain angle α in relation to the horizontal plane. The angle α is preferably of the order of 10-20°.

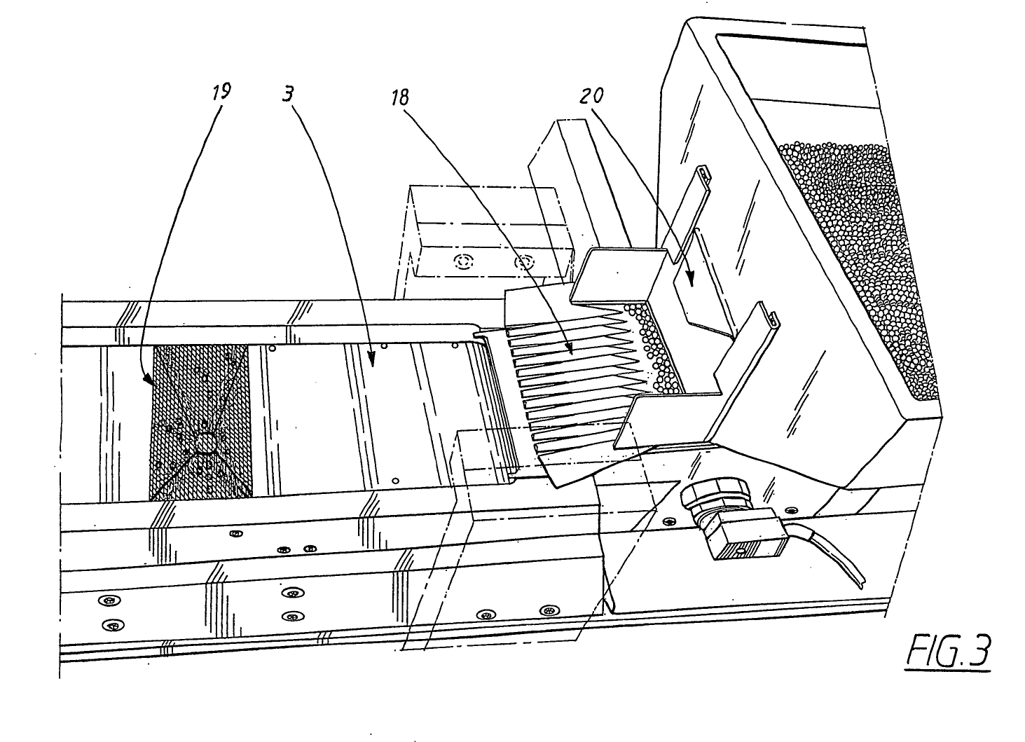

It is an underlying principle behind the invention that it is designed for separating unwanted loose particles 29 (for example smaller than 2 mm) which are to be found among the stream of granules 2 (for example larger than 2 mm). For this purpose, the system comprises a special separating arrangement which is shown in detail in FIG. 3. More specifically, this separating arrangement consists of a first screen arrangement 18 and a second screen arrangement 19. The first screen arrangement 18 is preferably connected mechanically to the hopper 1. In addition, these units are designed so that together they form a vibrating feeder which is arranged in such a way that the granules 2 are fed out of the hopper 1, past the first screen arrangement 18 and on to the conveyor arrangement 3.

The first screen arrangement 18 is suitably arranged in direct association with the opening 20 that is on the front of the hopper 1 and consists of a special component for separating loose particles, which can consist of contaminants, as will be described in detail below. Under the first screen arrangement 18 there is a separating arrangement 21 (see FIG. 1) by means of which loose particles can be separated and directed to a special container 22 for such particles. FIG. 1 shows a number of such sorted and separated particles with the reference numeral 29.

The second screen arrangement 19 is arranged in a suitable position along the conveyor arrangement 3 downstream of the first screen arrangement 18. The second screen arrangement 19 consists of a sieve or screen component which is preferably designed with a metal grid which extends principally in the same plane as the surface of the conveyor arrangement 3. The grid is so arranged that it forms openings that are smaller in size than the size of the granules 2 in question, but larger than the very small particles (for example less than 0.2 mm) that have been able to pass through the first screen arrangement 18 as a result of their large quantity and small weight. The small particles will then fall down through the openings in the grid. Below this grid there is an opening 23 (cf. FIG. 1) which takes the sorted and separated particles to another container 24.

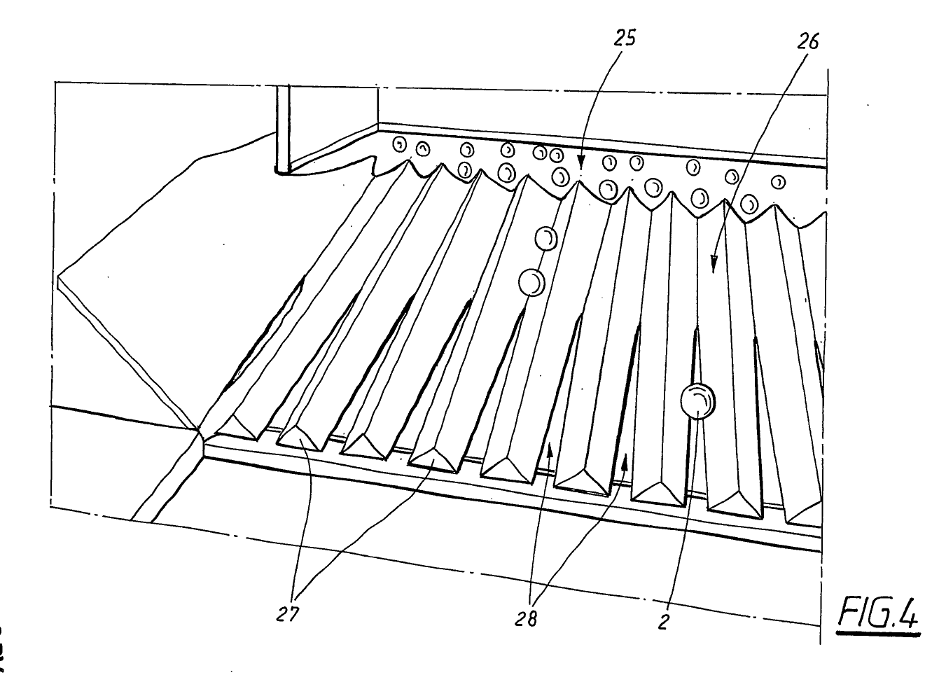

FIG. 4 is a somewhat enlarged view of the first screen arrangement 18 viewed obliquely from the front. According to the invention, the first screen arrangement 18 is designed with a first section 25 that consists of a plane and principally horizontal surface, which changes into second section 26 which is somewhat inclined in relation to the said first section 25 and which, in addition, is designed with a plurality of finger or rod shaped projections 27 pointing towards the conveyor arrangement 3. A second section 26 is preferably used with about ten projections, but variations of this number are possible within the framework of the invention. As shown in FIG. 4, the first screen arrangement 18 is designed with an upper side that changes from being principally plane to form principally V-shaped valleys or chutes, which change to form spaces 28 between the respective projections 27. These chutes define corresponding internal walls that have a V-shape in cross-section, with an angle that is of the order of 0°-180°, preferably 90°.

The spaces 28 are designed with an opening that widens gradually in the direction of transportation. By the direction of transportation is meant the direction in which the granules 2 are fed while the system is operating. In this way, a rake is created between each projection 27, whereby any loose particles to be found among the granules 2 will fall down in the abovementioned V-shaped valleys and will thereafter be directed to a corresponding space 28 between two adjacent projections 27. Thereafter the particles are directed down to the container 22 (see FIG. 1) for collection. In this way, it can be said that the first screen arrangement 18 is self-cleaning and is arranged to sort out particles that are less than a certain size. The first screen arrangement 18 is suitably dimensioned and designed in such a way that the particles that are separated are of such a size that otherwise there would have been a risk of them blocking the subsequent second screen arrangement 19, and smaller.

The dimensions and design of the respective projections 27 can vary, but as claimed in the preferred embodiment of the invention, the projections 27 are designed in such a way that the opening 28 between the respective ends of the projections 27 (that is at the far end of the respective projections 27) is smaller than the expected diameter of the granules 2 in question. In this way, it is ensured that no granule 2 passes through between the projections 27, but is taken past the ends of the projections 27 and on to the conveyor arrangement 3. In addition, the section 26 of the screen arrangement 18 that comprises the projections 27 is designed to be at a certain angle in relation to the horizontal plane. This angle is preferably of the order of 0°-30°, preferably approximately 15°.

As also shown in FIG. 4, the respective projections 27 have a triangular cross-section that defines a principally V-shaped channel that commences at an area in the transition between the first section 25 and the second section 26 and which changes into an opening between two adjacent inclined projections 27. In addition, the projections 27 are designed in such a way that the spaces 28 define a gradually widening V-shape if they are viewed from above. The spaces 28 can be said to form a rake angle, which is preferably of the order of 2°-30°, preferably approximately 3°. The choice of this rake angle is determined in such a way that granules or particles that might have blocked the openings 28 are freed by means of the screen arrangement's 18 forward and backward movement, whereby the screen arrangement 18 becomes self-cleaning. The choice of the rake angle is also determined depending upon a plurality of parameters, in particular the friction between the respective projections 27 and the granules 2 on the surfaces of the projections 27 on which the granules 2 are moving. The choice of angle is also determined depending upon the elasticity and hardness of the granules 2 and the angle of inclination of the projections 27 in relation to the horizontal plane.

In order to achieve increased separation and an increased capacity of the arrangement as claimed in the invention, this can comprise two or more arrangements of the same type as the abovementioned first screen arrangement 18, which can then be positioned directly after each other in the flow direction of the granules 2. In other words, a stepwise separating of unwanted particles is obtained, whereby a large part of these particles are separated in a first step and an additional quantity (of the unwanted particles which, in spite of everything, remained with the granules without being separated between the projections in the first screen arrangement) will be separated in a second step. In this second step, an additional screen arrangement is thus provided of the same type as shown in FIG. 4. By means of this stepwise separating with two consecutive screen arrangements, an extremely high proportion of the unwanted particles will be able to be separated, more specifically of the order of 95% or more.

The invention constitutes a solution to a problem connected with screening or sorting of small particles that consists of known screen arrangements running the risk of being blocked by such unwanted particles. This risk of blocking is particularly great when the particles are of a size that principally conforms to the mesh size 0.2 mm to 2 mm in the second screen arrangement 19 in accordance with what has been described above.

According to an additional aspect of the invention, an improved method is provided for manufacturing electrical power cables, preferably power cables for medium and high voltage. As was mentioned by way of introduction, such power cables normally comprise a metal conductor that is surrounded by an insulating material, such as polyethylene. The manufacture of such power cables is normally based on an inner electrically-conductive core first being provided with an inner semi-conductive layer which is then covered by an insulating layer. Thereafter, an outer semi-conductive layer is applied, which is then covered by a covering that provides protection against the environment, for example as a result of moisture and dirt on the cable.

The insulating layer and the two semi-conductive layers can be designed as a sandwich construction whereby the insulating layer is surrounded by the semi-conductive layers. According to known technology, the insulating layer can have a thickness that is of the order of 3-30 mm. These three layers are then extruded on the inner electrically conductive core.

As mentioned above, the raw material for the insulating layer consists of pellet-shaped or granular elements. In connection with a manufacturing process, this raw material is fed first through an inspection system, suitably of the type described above with reference to FIGS. 1 and 2. In connection with this step, unwanted loose particles, for example in the form of loose contaminants that are not an integral part of the actual granules, are separated by means of the abovementioned screen arrangements 18, 19. In addition, there is a separating of the granules that comprise contaminants, which is carried out by means of the detector 9 and the sorting and separating arrangement 11. Taken as a whole, a process is achieved for manufacturing power cables with a very high degree of cleanness, that is in principle all contaminants, both loose contaminants and contaminants in the granules, can be separated before the insulating material is finally formed and integrated with the two semi-conductive layers.

The two screen arrangements 18, 19 that are used for separating unwanted particles can be placed in a suitable position in a process for manufacturing a power cable, between the feeding of a raw material of polyethylene and the forming of an insulating material for the power cable. For example, the screen arrangements 18, 19 can be placed immediately before a production extruder arranged to apply an insulating layer on a power cable. According to an additional example, the screen arrangements 18, 19 can be placed in a position that precedes packaging and dispatch of a certain quantity of a pellet-shaped or granular raw material for the manufacture of power cables, that is at the premises of a manufacturer of such raw material. According to yet another example, the screen arrangements 18, 19 can be placed at a reception station for incoming raw material at the premises of a power cable manufacturer. According to the example that is described above with reference to FIGS. 1 and 2, the screen arrangements 18, 19 can be placed in connection with a system for inspection and fault control of the granular raw material, which can be carried out, for example, at the premises of a manufacturer of the raw material, at the premises of a power cable manufacturer or at the premises of an independent institution for such inspection and fault control. The invention can thus be implemented in principle anywhere in the whole chain between production of the raw material and final manufacture of a power cable.

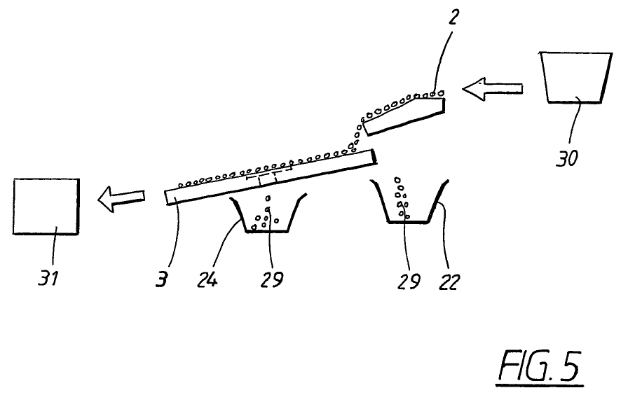

FIG. 5 shows the invention in its most general form, that is in any position between a source 30 of a raw material for pellet-shaped or granular elements 2 and a work station or process unit 31 at which the elements 2 are incorporated in a subsequent process. The elements 2 are taken from this source 30 (as shown schematically by an arrow) and go forward to the first screen arrangement 18, onwards along a conveyor arrangement 3, and preferably also past the second screen arrangement 19. Thereafter the inspected elements 2 are taken to a subsequent process unit 31 (as shown by another arrow). As described above, the process unit 31 can consist, for example, of an extruder for applying insulating material onto a power cable. Alternatively, the process unit 31 can consist of a packing station or a dispatch station for delivery of finished pellets from a manufacturer, or a system for optical inspection of the elements 2. In association with the first and the second screen arrangements 18, 19, there are containers 22, 24 respectively for collecting the separated unwanted particles 29.

The invention is not limited to the embodiments described above and illustrated in the figures, but can be varied within the framework of the following claims. For example, the invention can be used in connection with the manufacture of electrical power cables, at a suitable place in the process between the reception of a granular raw material and a final process unit for manufacturing the said power cables. The invention is suitably utilized for the sorting and separating of particles that are found in various kinds of granules of polyethylene intended for the manufacture of power cables, but can also be used for separating other types of unwanted particles that there is a desire to separate from a flow of wanted elements. The invention can thus be implemented with other pellet-shaped and granular elements, for example in the form of rice, corn, peanuts and other elements in the shape of small balls or grain.

It should be noted that the invention can be implemented in such a way that both the first screen arrangement 18 and the second screen arrangement 19 are arranged in the system for optical detection as described above. However, the invention is not limited just to this embodiment, but can be realized with either the first screen arrangement 18 or with a combination of the first screen arrangement 18 and the second screen arrangement 19. Similarly, the placing of the respective screen arrangements 18, 19 can vary.

The invention can be used in connection with a station for optical inspection of granules, as shown in FIGS. 1 and 2. The invention is not limited to the separating screen arrangements 18, 19 being placed before (that is upstream of) the optical detector 9 (cf. FIG. 1), but the screen arrangements 18, 19 can alternatively be placed after (downstream of) the said optical detector 9.

In addition, the invention is not limited to being used with optical detection as described above, but can be used with all types of conveyor arrangements for various discrete elements that are fed to some form of workstation and where there is a need to sort and separate unwanted loose particles.

1. (not entered)

2. (not entered)

3. (not entered)

4. (not entered)

5. (not entered)

6. (not entered)

7. (not entered)

8. (not entered)

9. (not entered)

10. (not entered)

11. (not entered)

12. (not entered)

13. (not entered)

14. (not entered)

15. (not entered)

16. (not entered)

17. (not entered)

18. (not entered)
